(19) United States
(12) Patent Application Publication
(10) Pub. No.: US 2011/0022412 A1
(43) Pub. Date: Jan. 27, 2011

(54) DISTILLATION AND USE OF HETEROGENEOUS HEALTH DATA

(75) Inventors: Wyatt D. Jackson, Bothell, WA (US); Annie Lamour, Seattle, WA (US); Eugene Lee, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/510,130

(22) Filed: Jul. 27, 2009

(51) Int. Cl. G06Q 50/00; G06N 5/02; G06F 15/16; G08B 21/00

(52) U.S. Cl. 705/3; 705/2; 706/47; 709/206; 340/540

(57) ABSTRACT

Health data may be received in various forms from various sources, and rules may be applied to perform reasoning on the data. In one example, health data from a variety of sources is distilled into a particular representation. Facts (such as conditions with which the patient has been diagnosed, medications that the patient is taking, etc.) are distilled into a particular medical vocabulary. These facts may then be exposed to the expert system through an object model, which applies rules to determine which alerts to issue to a patient. The alerts may then be communicated to the patient. Raw health data may be received in one form, and the raw data may be expressed in one of several standard medical terminologies, so that expert systems that expect to use a particular terminology can perform reasoning on the facts.

### BACKGROUND

Computer systems have been used in the healthcare industry for some time, but use of such systems has been mainly by providers of healthcare. In the near future, it is likely that it will become more common for healthcare consumers to use computers to manage their healthcare. Thus, there is reason to develop applications that address issues that are particular to consumers.

Systems such as the MICROSOFT HEALTHVAULT platform are available, and such platforms may be used to help patients to store and organize their healthcare information. In the future, it is likely that many patient-oriented applications will be built on these types of platforms, and that these applications may assist patients with various types of healthcare issues. However, one issue that arises in building such an application is that the underlying information about a patient's healthcare may be in various different forms, some of which are unstructured or non-standard. Another issue that arises is that—even if the information could be expressed in a standard form—there are several different standard systems for expressing medical conditions, and there are a variety of levels of abstraction at which such information can be described.

Moreover, information that is relevant to a particular patient may come from a variety of sources—e.g., in the case of hereditary disease, information that is relevant to a patient's health may come from the health records of a family member rather than from the patient himself.

Platforms that address some or all of these issues can simplify the process of creating healthcare applications.

### SUMMARY

A platform may be provided to store and organize healthcare data for a patient and his or her family, and applications may be built on the platform. The healthcare data may come from a variety of sources, and may be in a variety of formats. For example, data could be entered as text by a patient. Or, the data could come directly from a healthcare provider such as a hospital or doctor's office, and could be in any format (e.g., text, audio, image, etc.). Applications, such as expert systems that perform various types of reasoning on the data, may be built on the platform.

In order to support the use of healthcare data by applications, the platform may provide various features. As one example, the platform may have the ability to store raw healthcare data in any form, while also supporting the conversion of these data into standard medical vocabularies, such as the Systematized Nomenclature of Medicine—Clinical Terms (“SNOMED CT”), or the Mayo Clinic system of terminology. Additionally, the platform may provide an object model that exposes the data at various levels of abstraction. For example, the object model may expose the original raw data, or the expression of a particular condition in a particular medical vocabulary, or some higher level abstraction about the data.

Applications may use the data—as exposed through the object model—in order to perform various types of reasoning on the data. In one example, an application makes recommendations about a patient's healthcare based on facts that are known about the patient and his or her family. For example, if a patient's parents both have diabetes, then—assuming that the patient's parents have given permission for their data to be used in this manner—an application could determine that the patient himself is at risk for diabetes. Thus, the application could present an alert to the patient, recommending that the patient discuss his or her diabetes risk with his or her doctor.

The MICROSOFT HEALTHVAULT platform is one example of a platform that may be used to store patient healthcare data, and on top of which applications may be built. The MICROSOFT HEALTHVAULT platform allows patients to store and organize their own healthcare information securely, and also recognizes the concept of family members. Thus, by exposing to applications certain data about the patient and (assuming appropriate permissions are in place) about the patient's family, the system can implement various forms of medical reasoning to provide personalized health alerts to the patient. (However, the subject matter herein is not limited to the MICROSOFT HEALTHVALUT platform, and may be used with any appropriate platform.)

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example system in which data about a patient's health may be analyzed.

FIG. 2 is a block diagram of some examples of health information that may be tagged and stored.

FIG. 3 is a block diagram of a piece of raw information, and a medical vocabulary in which the raw information may be expressed.

FIG. 4 is a block diagram of an example rules engine that uses facts to generate information.

FIG. 5 is a block diagram of an example way in which a finding may be presented to a patient.

FIG. 6 is a flow diagram of an example process in which health information may be analyzed to generate alerts.

FIG. 7 is a block diagram of example components that may be used in connection with implementations of the subject matter described herein.

### DETAILED DESCRIPTION

The use of computers to store and organize records has entered many fields of endeavor, and the healthcare industry is no exception. While doctors and hospitals used to keep records of their patients entirely on paper, many healthcare providers now use databases to store records electronically. While computer-based technologies for managing healthcare records has widespread adoption among healthcare providers, the next group to adopt computer applications for healthcare is likely to be healthcare consumers. Systems such as the MICROSOFT HEALTHVAULT platform allow patients to store information related to their health.

The MICROSOFT HEALTHVAULT platform allows people to use various applications, which perform various kinds of actions on the stored items of data. One type of action that a person might want to perform is to obtain personalized healthcare recommendations based on the health history of the person, or that of his or her family. If certain types of information are available about the person (e.g., conditions with which the person has been diagnosed, medications being taken, family history of disease, etc.), it is theoretically possible to use that information to automate the process of making personalized healthcare recommendations.

However, there are certain challenges in implementing such a system. First, there are various different vocabularies for expressing medical conditions (e.g., the Systematized Nomenclature of Medicine—Clinical Terms (“SNOMED CT”) and the Mayo Clinic system of terminology). An expert system can perform medical reasoning based on a patient's condition, in order to make recommendations to the patient. However, the expert system may be expecting information about the patient's condition to be expressed in one particular vocabulary. Complicating matters is the fact that the database record may express the patient's condition in any of the existing medical vocabularies—or even in an unstructured form that is not related to any of the standard medical vocabularies. For example, SNOMED CT might use the structured term “Burn of skin->severe->fifth toe->left” to describe a severe skin burn on a patient's left small toe. The Mayo Clinic system might use different terms and a different structure to describe the same condition. The database record might contain the text of a doctor's notes, such as “Patient has a third degree burn on his left foot (small toe).” There may be reason to allow an expert system to choose the particular vocabulary that it will use when it evaluates a patient's medical history. There may also be reason to keep, in its original form, the raw data from which that history is derived.

The subject matter described herein may be used to process medical data that are received in various forms, so that the data can be used by applications. The techniques provided herein allow data to be retained in their raw form without being changed, while also distilling the data into a model that can be used by various applications. One example of an application is an expert system that performs rule-based reasoning on facts in a patient's medical history (including, possibly, facts in the medical histories of the patient's families). Such a system may be used to make recommendations to the patient. For example, if the patient has a history of high blood glucose readings, the system could be used to recommend that the patient be evaluated for diabetes. Such recommendations could be presented to the patient in the form of alerts. The alerts could be provided in various forms—e.g., as items on a web page, by e-mail, by physical mail, through pop-up messages, through a desktop application (or other application that runs on a user's machine), by telephone call, etc.

The expert system may expect to perform rule-based on reasoning on facts that are expressed in a particular way—e.g., the expert system may expect medical conditions to be expressed in the SNOMED CT vocabulary. However, the underlying data may not have been entered in the SNOMED CT vocabulary, and there may be reason to retain the raw data in its original form. Thus, the subject matter herein may be used to separate, conceptually, the storage of the original data from the data model that is presented to an application—thereby allowing the raw data to be retained in its original form, while also allowing an application to work with data in the form that the application wants to use. It is noted that interpretations of data may change depending on context (e.g., the Mayo Clinic may have one interpretation of a given set of data, and the Cleveland Clinic may have a different interpretation of the same set of data). Moreover, a given entity's interpretation may evolve over time. Retaining the raw data allows these interpretations to change over time or context.

Techniques provided herein may be used to implement, or to augment, a platform on which applications may be built. For example, if the techniques herein are incorporated into the MICROSOFT HEALTHVAULT platform, then the expert system mentioned above could be built as an application on that platform. Thus, HEALTHVAULT could be used to store raw data about a patient, and techniques described herein could be used to distill that raw data into a particular object model. The object model may be based on a particular vocabulary for expressing medical conditions, or may be based on a set of several vocabularies, or could be based on some other type of abstraction. The object model could then be presented to the application, which could perform some type of reasoning on the data in order to make recommendations to the patient. (The expert system could implement rules that have been determined by doctors or other experts.) While the MICROSOFT HEALTHVAULT platform is used as an example of a system that stores healthcare data, the principles described herein could be applied to any system in which healthcare data is stored.

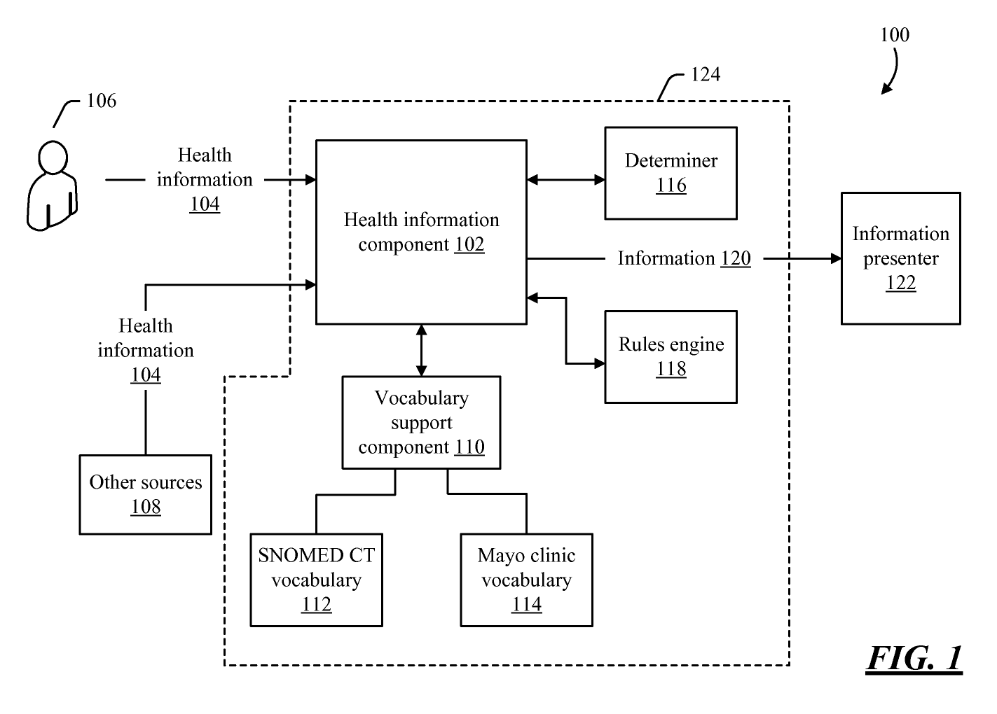

Turning now to the drawings, FIG. 1 shows an example system 100 in which data about a patient's health may be analyzed to provide suggestions or other information to a patient. In system 100, a health information component 102 receives health information 104 concerning a patient. (Health information 104 may be, for example, information that describes a physical condition of a patient's human body, or that describes or relates to a physical treatment or other procedure performed on the patient's human body.) Health information component 102 may be, or may comprise, a health information system such as the MICROSOFT HEALTHVAULT platform (although health information component 102 could be based on some other product or technology, and is not limited to any specific product). Health information component 102 may receive health information 104 from the patient 106 (to whom the information pertains), or may receive health information 104 from one or more other sources 108. Thus, in one example, patient 106 enters health information 104 into health information component 102 (e.g., by keying in the information through a web browser). However, health information 104 could be received from any source, such as a doctor, hospital, clinic, etc. For example, a hospital may maintain patient records in electronic form, and may (with the patient's permission) provide these records to health information component 102, so that these records can be associated with patient 106's other health information. In general, health information 104 could be in any form and different pieces of healthcare information could be in different forms. Thus, different pieces of healthcare information could be in the form of text, audio, image, etc. Moreover, different pieces of healthcare information could be entered in structured or unstructured forms (e.g., some pieces might be free-form text, while others might be text that represents a condition in a specific way within a standard medical vocabulary such as SNOMED CT.)

While the subject matter herein is not limited to any specific product, in one example health information component 102 may provide certain features. For example, health information component 102 may allow a patient to create an account in his name, so that health information for that patient is stored in that account. Additionally, health information component 102 may recognize the concept of a family, and may maintain an association between the patient and members of his or her family, so that a patient may grant some or all of the patient's family members access to the patient's private health information. Moreover, since health information component 102 may store sensitive information about people's health and medical history, health information component 102 may employ various measures to prevent private information from being divulged to inappropriate parties or under inappropriate circumstances.

In one example, health information component 102 may store information in an unstructured form. For example, a record of information in health information component 102 may have some arbitrary data (e.g., text, an image, an audio record, etc.), and may also have a tag indicating the type of the data. Thus, a record might have the tag “condition” and the arbitrary data may be the text string “Type-2 diabetes”. As another example, the arbitrary data could be an audio recording of a doctor saying “This patient has type-2 diabetes”, or an image of a handwritten note saying that the patient has type-2 diabetes. As another example, the arbitrary data might be the SNOMED CT code (or some other vocabulary's code) for type-2 diabetes. “Condition” is one example of a tag; other examples may include “medication” (with associated data such as “This patient takes 40 mg of Nexium per day”), “diagnostic test” (with associated data such as “This patient had an X-ray on Jan. 1, 2009” along with a file containing the X-ray image). These records could be entered by patient 106, or could be provided by another source, as previously described.

While health information component 102 may store unstructured records such as those described above, health information component 102 may also provide support for formal medical vocabularies. Thus, health information component 102 may use a vocabulary support component 110 that assists in processing records that use terminology from a medical vocabulary. Examples of such vocabularies are the SNOMED CT vocabulary 112 and the Mayo Clinic vocabulary 114. (Vocabulary support component 110 may have the ability to support one or more specific vocabularies. However, it is noted that data could be labeled based on a vocabulary that is not explicitly supported by vocabulary support component 110.)

As noted above, information about a patient's health may be stored in health information component 102 in an unstructured form, although an expert system that performs reasoning about the patient's health condition may expect the patient's condition to be stated in a particular vocabulary (or, more generally, may expect to use a particular object model that exposes some view of the underlying health information). Thus, health information component 102 may use a determiner 116, which determines what conditions the patient has, based on the unstructured information. For example, if a data record contains the text “patient has type-2 diabetes”, determiner 116 could evaluate this text and determine that the statement corresponds to the patient having the condition that SNOMED CT describes as “44054006 diabetes mellitus type-2”. Thus, determiner 116 has the role of taking raw data received from various sources, and putting that data into a form that can be used by an expert system. It is noted that medical information is not merely a set of conditions, but may also include other types of information such as medications, lab tests, procedures, blood types, and a determiner component could be used to identify these other types of information from raw data, as well as identifying medical conditions expressed in the raw data.

Rules engine 118 is a component that applies rules to determine what actions to take based on the information known about a patient. Rules engine 118 is an example of an expert system. The rules employed by rules engine may have been devised, for example, by doctors or other health care professionals. For example, doctors might believe that a combination of a high blood glucose reading and a history of fainting spells indicate that the patient is at risk for diabetes. Or, doctors might believe that a history of chronic heartburn that has not been remedied by acid-reducing medication suggests that the patient might have an H. Pylori infection. Any such rules could be created, and rules engine 118 could apply those rules to whatever is known about the patient.

It is noted that rules could operate on information that is known about a particular patient, but do not have to be limited to using information about one specific patient. For example, the fact that a patient's mother and grandmother have a history of breast cancer might suggest that the patient herself is at risk for breast cancer. If the patient's mother and grandmother have given permission to have their health information used in this way, rules engine 118 could apply rules to what is known about the health of a patient's family. Health information component 102 could have mechanisms that allow different patients to declare their relationships to other patients, and to express whether they are willing to allow rules engine 118 to access their information for the purpose of assessing the health of a family member. In general, rules could operate on any collection of patients (assuming that appropriate permission has been given). For example, rules could be used to determine genetic similarities between unrelated patients, or could compare a patient's condition to other patients with known genetic similarities. Rules could also be used to look for patterns based on factors such as geographic location (e.g., rules could be used to look for disease clusters in a particular geographic location).

When rules engine 118 applies rules to known facts, these rules may generate one or more findings or conclusions. For example, as noted above a high blood glucose reading with a history of fainting spells might indicate a risk for diabetes. Based on these conclusions, health information component 102 may generate certain information 120 to be communicated in a tangible form to a patient. For example, if the conclusion (based on the action of rules engine 118) is that the patient is at risk for diabetes, the information 120 that health information component 102 might present to a patient is a text alert such as, “You are at risk for diabetes based on your history. You may want to discuss this risk with your doctor.” This information could be provided to some type of information presenter 122 so that the information can be communicated to a patient. Information presenter 122 could take any form. In one example, a patient interacts with health information component 102 through a web browser, so information presenter 122 could take the form of a server application that is accessed by a patient through such a web browser. In other examples, information presenter 122 could be a system that e-mails information to a patient, that sends the patient information via physical mail, or that places a telephone call to the patient, etc.

It is noted that various functions discussed above are shown in FIG. 1, by way of example, as being implemented by distinct components. For example, FIG. 1 shows an example in which health information component 102, vocabulary support component 110, determiner 116, and rules engine 118 are separate components that communicate with each other and that interact with each other. However, any one or more of these functions could be merged into a single component (or could be separated out into a larger number of components than are shown). Thus, in one example, these various functions could be viewed as being implemented by a single component 124, as indicated by the dashed-line box enclosing the various other components.

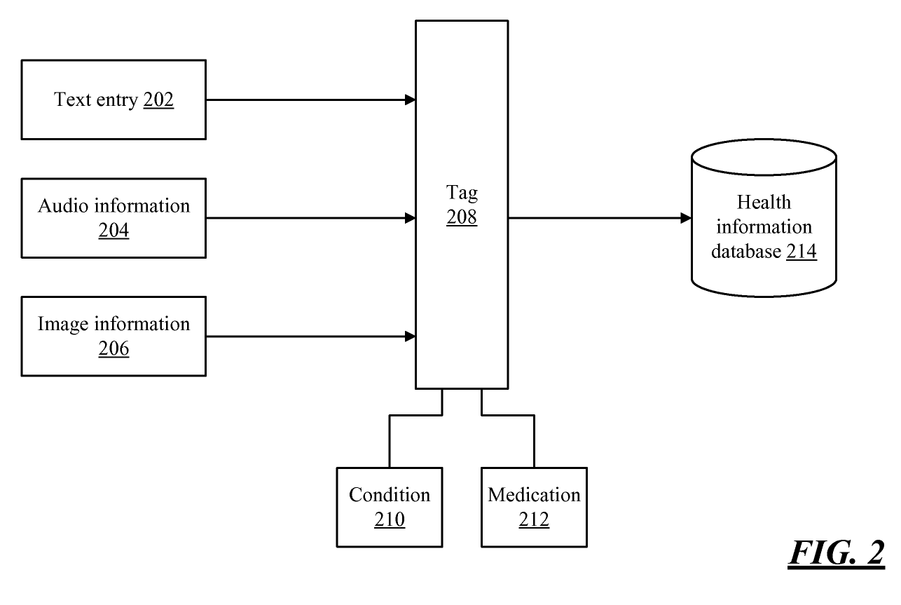

As noted above, information about a patient's healthcare may be entered into health information component 102 in a tagged, unstructured form. FIG. 2 shows some examples of health information that may be tagged and stored.

Raw information concerning a patient's health care may take various forms. For example, FIG. 2 shows health information in the form of text entry 202, audio information 204, and image information 206. A user of health information component 102 (shown in FIG. 1) may enter information in the form of text. Or, information could be provided in the form of an audio recording (e.g., a doctor's spoken notes about a patient examination, a recording of a patient's heart beating as heard through a stethoscope, etc.). Or, as another example, the raw data could be an image (e.g., a scanned image of a handwritten note, an image of an X-ray, etc.). The raw information about a patient's health could take any form.

Once the raw information has been made available, a tag 208 may be applied to the raw information. The tag may provide a description of the general category that the information belongs to. For example, if the underlying raw information is describing a patient's condition (e.g., a text entry that state “This patient has type-2 diabetes”), then the tag 208 that is applied may be a “condition” tag 210. On the other hand, if the information relates to a medication that the patient is taking (e.g., a text entry that says, “This patient takes 40 mg of Nexium per day”), then the tag 208 that is applied may be a “medication” tag 212. Condition and medication tags are examples of tags that could be applied, although any type of tag could be applied.

When the raw information received has been tagged, the information may be stored in health information database 214. (Alternatively, untagged information could be stored in health information database 214, and this the tags could be applied based on information that is subsequently learned or discovered.) Health information database 214 may be part of health information component 102 (shown in FIG. 1), and health information component 102 may store information in, and retrieve information from, database 214.

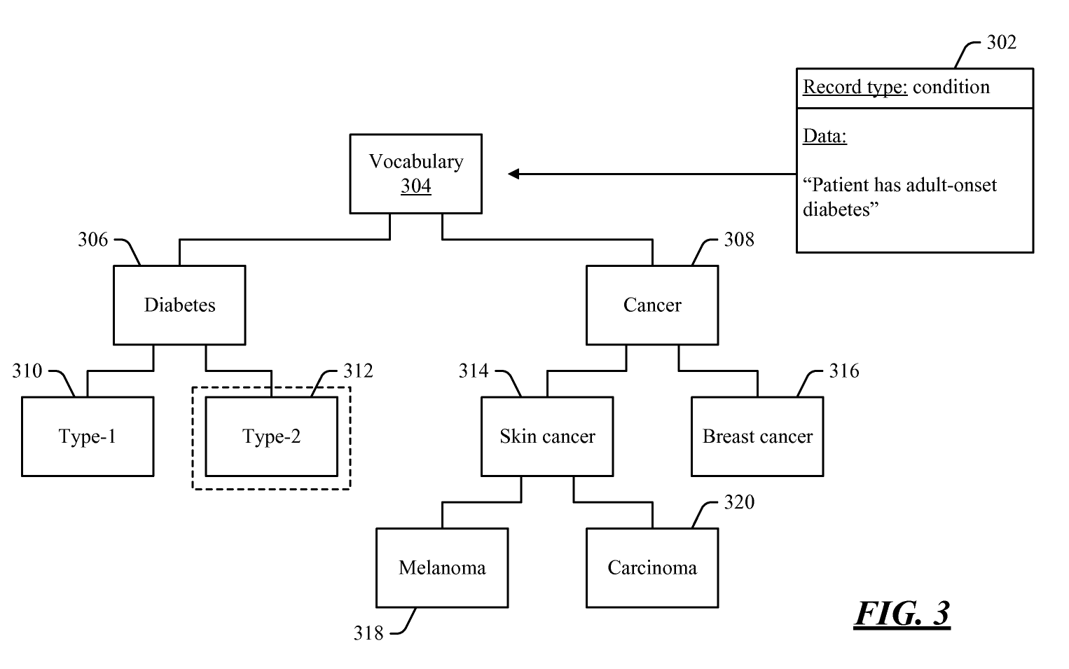

As noted above in connection with FIG. 1, one action that may be performed in order to apply rules to facts is to take raw information from various sources and to express the raw information in some accepted medical vocabulary. FIG. 3 shows an example of a piece of raw information that may be expressed in a medical vocabulary.

Record 302 is a record that pertains to a patient's medical history. In the example of FIG. 3, record 302 has a “condition” tag (labeled in the drawing as the “record type”) to indicate that the record relates to a patient's condition, and raw data that is in the form of text. The text shown states “patient has adult-onset diabetes” (which is a phrase that is often used to describe type-2 diabetes). Health information component 102 (shown in FIG. 1), or some sub-component of health information component 102, may determine what condition is expressed by the data contained in record 302. That condition may be expressed in a medical vocabulary, such as the SNOMED CT vocabulary or the Mayo Clinic vocabulary. For purposes of illustration, FIG. 3 shows a simplified vocabulary 304.

Vocabulary 304, in this example, is a structured vocabulary that can be used to describe a patient's condition at various levels. Vocabulary 304 has terms for the conditions “diabetes” (block 306) and “cancer” (block 308). These high-level conditions may be associated with various sub-conditions. For example, the diabetes condition may be associated with “type-1” (block 310) and “type-2” (block 312). The “cancer” condition may be associated with the “skin cancer” (block 314) and “breast cancer” (block 316). The “skin cancer” sub-condition may be associated with melanoma (block 318) and carcinoma (block 320). The small number of conditions shown in vocabulary 304 is a simplification for purpose of illustration. A real-world medical vocabulary such as SNOMED CT recognizes a larger set of conditions at various different levels of detail.

The information contained in record 302 may be expressed in a vocabulary, such as vocabulary 304. By performing an analysis of record 302, it may be determined that the place within vocabulary 304 to which record 302 corresponds is type-2 diabetes (block 312), as indicated by the dashed line surrounding that block. The analysis could be performed in any manner—e.g., feature extraction techniques could be performed on the text contained in record 302 (or on text extracted from an audio recording, or from an image of a handwritten note, contained in such a record).

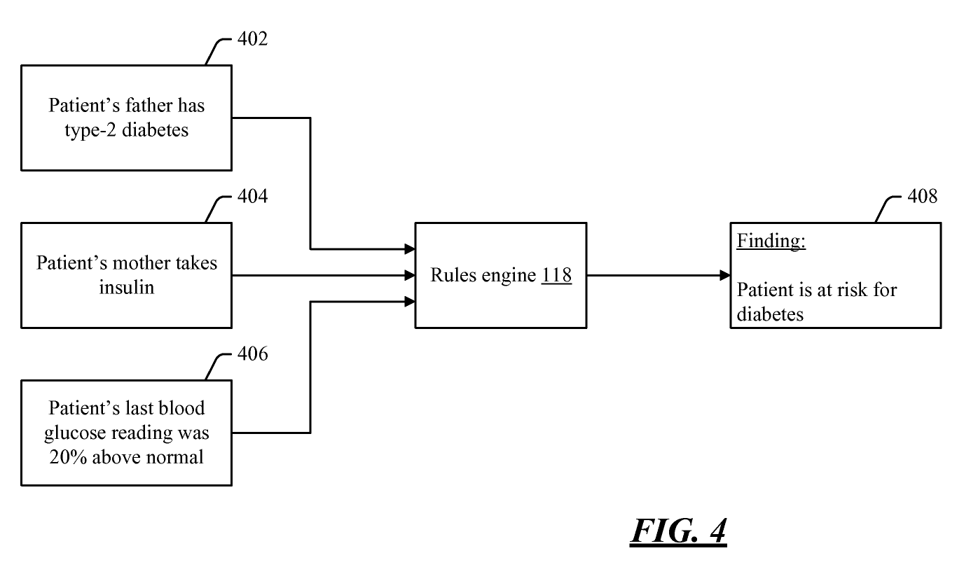

As noted above in connection with FIG. 1, a rule engine may apply rules to facts about a patient's health (or about the health of family members) in order to generate information that may be communicated to the patient. FIG. 4 shows an example in which various facts are used by rules engine 118 to generate such information.

Rules engine 118 may receive various facts as input. These facts may be stored by health information component 102 (shown in FIG. 1), which may, for example, maintain the information in health information database 214 (shown in FIG. 2). (However, the facts might not be stored by health information component 102 and, in general, could be stored anywhere or could be received from any source.) The facts used by rules engine 118 may be facts relating to the patients health, or may be indications of the health of other people such as family members, people in similar geographic locations, people with genetic similarities, etc. (In order to prevent unauthorized use of other people's private medical information, appropriate permissions could be sought, and other appropriate privacy safeguards could be applied.)

Thus, rules engine 118 may use information such as “patient's father has type-2 diabetes” (block 402), “patient's mother takes insulin” (block 404), and “patient's last blood glucose reading was 20% above normal” (block 406). (The information is shown in FIG. 4 in a simplified text form, although the information received by rules engine 118 could be expressed in a formal vocabulary, as described above.) Rules engine 118 may receive the information, and may apply rules. For example, there may be rules (devised by doctors or other healthcare experts) that indicate how to determine that a patient is at risk for diabetes when the patient has not been diagnosed with that disease. For example, the fact that someone in the patient's family (at some defined level of consanguinity) has diabetes may suggest that the patient also has diabetes. Additionally, there may be markers that suggest that someone in the patient's family has diabetes, even if there is no direct record of that person having diabetes. Thus, block 402 indicates directly that the patient's father has diabetes. Block 404 indicates that the patient's mother takes a medication that is commonly associated with diabetes (although the record does not directly state that the patient's mother has diabetes). Block 406 indicates that the patient has had a test result that is sometimes associated with diabetes (although one high blood sugar reading is not considered medically conclusive for that disease).

The information at blocks 402-406, in this example, is inconclusive in the sense that none of these pieces of information prove that the patient has diabetes. However, rules engine 118 may have a rule stating that these facts suggest that there may be reason for the patient to investigate further. Thus, when rules engine 118 applies a rule to the facts shown, it may generate a finding 408. The finding, in this example, is that the patient is at risk for diabetes.

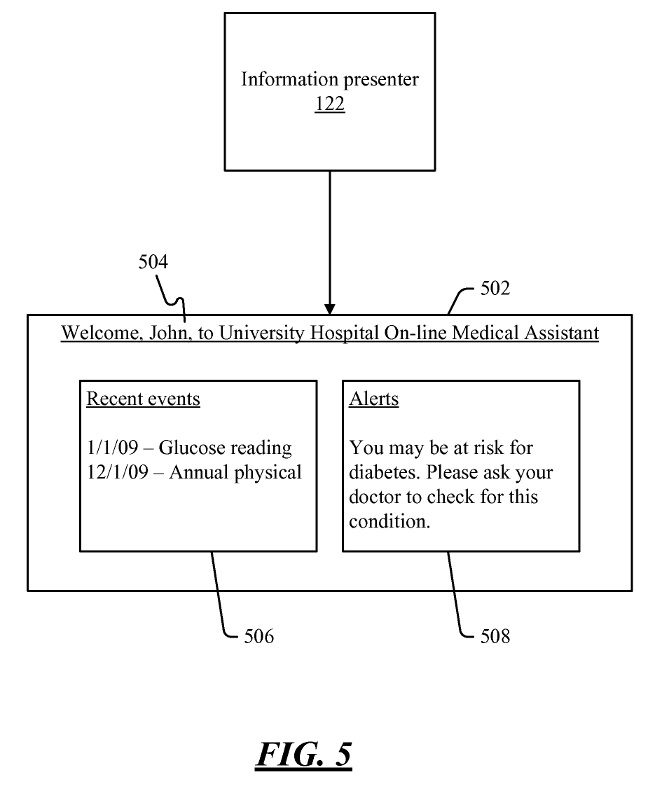

Finding 408 may be presented to a patient in some manner. FIG. 5 shows an example of a particular way in which a finding may be presented to a patient.

Finding 408 (shown in FIG. 4) may be expressed in the form of information that is communicated to a patient. For example, that finding may be expressed as the text string, “You are at risk for diabetes.” Information presenter 122 (which is discussed above in connection with FIG. 1) may be used to present that finding to a patient. For example, the patient may manage his or her health information using health information component 102 (shown in FIG. 1), and may access that information through a web site. Thus, information presenter 122 may be a component that renders information on the web site, so that the information can be viewed through the patient's web browser. That web browser may present a web page 502, which contains various information related to the patient's health.

In the example of FIG. 5, web page 502 shows a welcome message 504, as well as recent events 506 and alerts 508. The welcome message 504, recent events 506 and alerts 508 are merely examples of information that could be shown on web page 502, since any type of information could be shown.

Information presenter 122 may present the findings of a rules engine in the form of alerts 508. For example, alerts 508 show the text “You may be at risk for diabetes. Please ask your doctor to check for this condition.” This text represents the finding that was made by the rules engine.

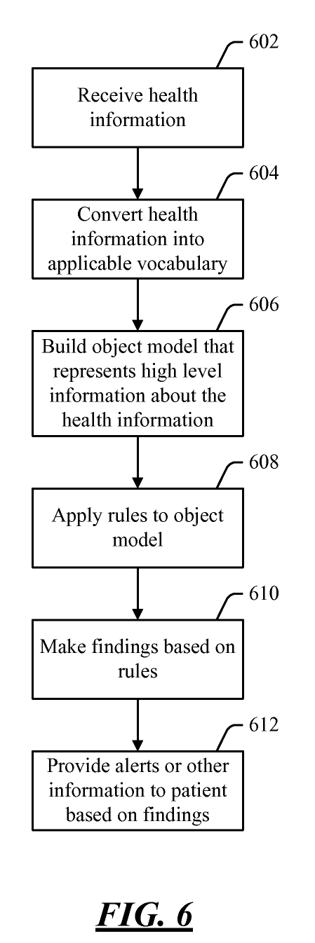

FIG. 6 shows an example process in which health information may be analyzed to generate alerts. Before turning to a description of FIG. 6, it is noted that the flow diagram in FIG. 6 shows an example in which stages of a process are carried out in a particular order, as indicated by the lines connecting the blocks, but the various stages shown in this diagram may be performed in any order, or in any combination or sub-combination.

At 602, health information may be received. As described above, the health information that is received may relate to a particular patient, or may relate to members of the patient's family. As also described above, the information may be received in any form—e.g., text, audio, image, etc.—and the information may be structured or unstructured. A piece of raw data with a tag (e.g., a “condition” tag, a “medication” tag, etc.) is an example of a piece of health information that may be received at 602.

At 604, health information may be converted to an appropriate vocabulary. For example, raw data that was received at 602 may be converted into a medical vocabulary such as SNOMED CT, or the Mayo Clinic vocabulary.

At 606, an object model may be built that represents high level information about the underlying health care data. For example, for a given piece of data, the object model may expose the raw data itself, or the data's representation in a particular vocabulary, or the data's place in some larger context. For example, the underlying piece of data may be a text entry that states “patient has type-2 diabetes.” The object model may expose this information at various levels. One example level is the raw text entry itself. Another example level is the SNOMED CT (or other vocabulary) representation of this condition. Another example level might be a view of all of a patient's hormonal conditions (diabetes being one example of a hormonal condition, since it is a condition in which the body produces insufficient quantities of the hormone insulin). The object model could expose any type of view of the available information. The object model may be hierarchical, in the sense that that some object models may be built upon other object models. Moreover, among the different object models, some may correspond to a particular vocabulary, and others may correspond to different levels of abstraction (where a particular medical vocabulary, such as SNOMED CT, represents one particular level of abstraction).

At 608, rules may be applied to the object model. For example, a rule may operate on facts such as “patient has SNOMED CT condition 44054006” (which is the number for type-2 diabetes), or may operate on higher-level facts such as “patient has one or more hormonal diseases.” As described above, any type of rules could be applied, and the rules could be based on whatever sort of connections between facts and findings could be devised by doctors or other healthcare experts.

At 610, one or more findings may be made based on applying rules to the available facts. Finding 408 (shown in FIG. 4) is an example of a finding that could be made at 610.

At 612, alerts or other information are provided to the patient based on the finding. For example, alerts 508 (shown in FIG. 5) provide an example of alerts that could be presented to a patient based on a finding.

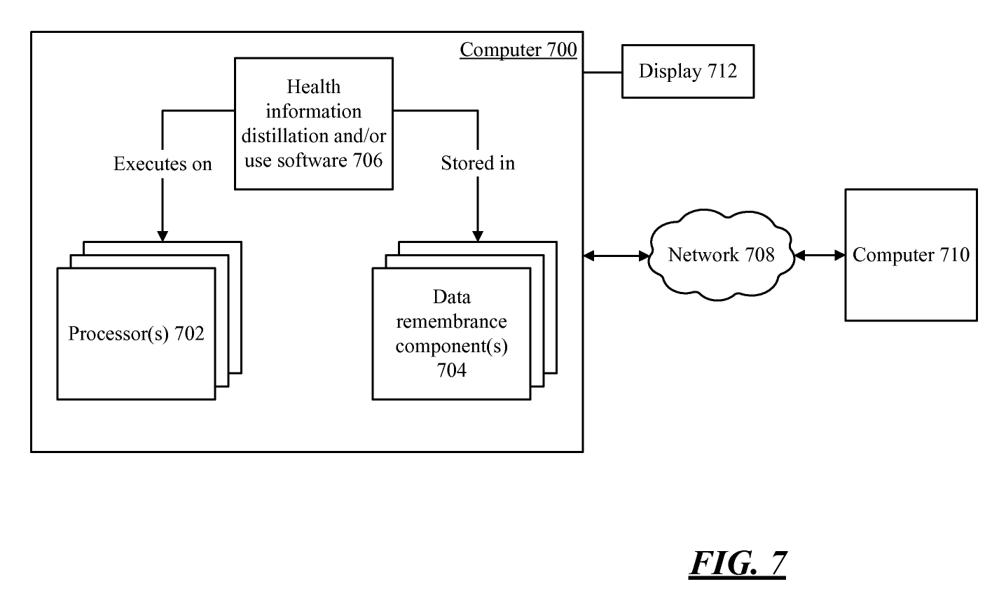

FIG. 7 shows an example environment in which aspects of the subject matter described herein may be deployed.

Computer 700 includes one or more processors 702 and one or more data remembrance components 704. Processor(s) 702 are typically microprocessors, such as those found in a personal desktop or laptop computer, a server, a handheld computer, or another kind of computing device. Data remembrance component(s) 704 are components that are capable of storing data for either the short or long term. Examples of data remembrance component(s) 704 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 700 may comprise, or be associated with, display 712, which may be a cathode ray tube (CRT) monitor, a liquid crystal display (LCD) monitor, or any other type of monitor.

Software may be stored in the data remembrance component(s) 704, and may execute on the one or more processor(s) 702. An example of such software is health information distillation and/or use software 706, which may implement some or all of the functionality described above in connection with FIGS. 1-6, although any type of software could be used. Software 706 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 7, although the subject matter described herein is not limited to this example.

The subject matter described herein can be implemented as software that is stored in one or more of the data remembrance component(s) 704 and that executes on one or more of the processor(s) 702. As another example, the subject matter can be implemented as instructions that are stored on one or more computer-readable storage media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 702) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 700 may be communicatively connected to one or more other devices through network 708. Computer 710, which may be similar in structure to computer 700, is an example of a device that can be connected to computer 700, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of using healthcare data, the method comprising:
using a processor to perform acts comprising:
receiving first data that describes a first healthcare fact, said first data being in a first form;
receiving second data that describes a second healthcare fact, said second data being in a second form that is different from said first form;
creating an object model that exposes information concerning items of data, said items of data comprising said first data and said second data;
applying a rule to said object model to generate a finding regarding a patient; and
communicating, in a tangible form to said patient, an alert based on said finding.

2. The method of claim 1, wherein said first healthcare fact comprises a physical condition of said patient, or comprises a treatment that has taken place on said patient.

3. The method of claim 1, wherein said second healthcare fact comprises a physical condition of a member of said patient's family, or comprises a treatment that has taken place on said member of said patient's family.

4. The method of claim 1, wherein said first healthcare fact relates to said patient, wherein said second healthcare fact relates to a member of said patient's family, and wherein the method further comprises:
retrieving said first data and said second data from a database that stores information concerning said patient and said patient's family; and
determining that said member of said patient's family has given permission to have said data concerning said member of said patient's family used in analysis of said patient's healthcare.

5. The method of claim 1, wherein said first data comprises a tag and an item of data, and wherein the method further comprises:
determining, based on said tag and on said item of data, what term in a standard medical vocabulary corresponds to said first data.

6. The method of claim 1, wherein said communicating comprises:
presenting said alert to said patient on a web site that said patient accesses through a web browser, by e-mail, through an application, through physical mail, or by telephone call.

7. The method of claim 1, wherein said receiving of said second data comprises:
receiving an indication that a member of said patient's family has been diagnosed with a particular disease.

8. The method of claim 1, wherein said receiving of said second data comprises:
receiving an indication that a member of said patient's family takes, or has taken, a particular medication.

9. The method of claim 1, wherein said first data or said second data describes a physical condition of a human body, or a physical procedure that has been performed on said human body, or a physical treatment that has been performed on said human body.

10. One or more computer-readable storage media that store executable instructions to provide healthcare alerts, wherein the executable instructions, when executed by a computer, cause the computer to perform acts comprising:
receiving healthcare data concerning a patient, a first item of said healthcare data being in a first form, a second item of said healthcare data being in a second form that is different from said first form;
exposing said healthcare data to an application, said healthcare data being exposed through an object model, wherein said object model provides said application a view of said healthcare data without changing said healthcare data;
applying, by said application, a rule to said healthcare data to generate a finding concerning said patient; and
communicating, in a tangible form to said patient, an alert based on said finding.

11. The one or more computer-readable storage media of claim 10, wherein said first item of said healthcare data describes a physical condition of said patient, or describes a treatment that has taken place on said patient.

12. The one or more computer-readable storage media of claim 10, wherein said second item of said healthcare data describes a physical condition of a member of said patient's family, or describes a treatment that has taken place on said member of said patient's family.

13. The one or more computer-readable storage media of claim 10, wherein said first item of said healthcare data relates to said patient, wherein said second item of said healthcare data relates to a member of said patient's family, and wherein said acts further comprises:
retrieving said first item and said second item from a database that stores information concerning said patient and said patient's family; and
determining that said member of said patient's family has given permission to have said data concerning said member of said patient's family used in analysis of said patient's healthcare.

14. The one or more computer-readable storage media of claim 10, wherein said acts further comprise:
maintaining an account of said patient, under which healthcare data pertaining to said patient is stored;
maintaining an association between said patient and members of said patient's family; and
using information regarding said patient and said members of said patient's family in generating said finding.

15. The one or more computer-readable storage media of claim 10, further comprising:
maintaining a web application through which said patient provides and accesses said healthcare data; and
providing said alert on a web page that said patient accesses in order to provide and access said healthcare data.

16. The one or more computer-readable storage media of claim 10, wherein said receiving of said healthcare data comprises:
receiving an indication that a member of said patient's family has been diagnosed with a particular disease.

17. The one or more computer-readable storage media of claim 10, wherein said receiving of said healthcare data comprises:
receiving an indication that said member of said patient's family takes, or has taken, a particular medication.

18. A system that provides health alerts to patients, the system comprising:
a processor;
a data remembrance device;
a component that is stored in said data remembrance device and that executes on said processor, said component comprising:
a health information component that receives items of health information, said items of health information comprising:
a first item that comprises structured information that represents a condition of a first person in a standard medical vocabulary; and
a second item that comprises unstructured information that represents a condition of a second person in text form;
a database in which said health information component stores said items of information;
a condition determiner that creates an object model based on said health information stored in said database, and that uses said object model to expose information concerning health conditions of people;
a rules engine that uses said object model to create a finding regarding a health condition of said first person; and
an information presenter that communicates, to said first person, an alert based on said finding.

19. The system of claim 18, wherein said second person is a family member of said first person, and wherein said health information component determines that said second person has given permission for information pertaining to said second person to be used in creating findings regarding said first person.

20. The system of claim 18, wherein said finding is that said first person is at risk of having a disease, and wherein said rules engine creates said finding based on rules that derive risks of one person from medical facts regarding said one person's family.
